(19) United States
(12) Patent Application Publication
(10) Pub. No.: US 2019/0045987 A1
(43) Pub. Date: Feb. 14, 2019

(54) AUTOMATICALLY MOVING FLOOR TREATMENT APPLIANCE

(71) Applicant: Vorwerk & Co. Interholding GmbH, Wuppertal (DE)

(72) Inventor: Michael BLUM, Wuppertal (DE)

(73) Assignee: Vorwerk & Co. Interholding GmbH, Wuppertal (DE)

(21) Appl. No.: 16/100,518

(22) Filed: Aug. 10, 2018

(30) Foreign Application Priority Data
Aug. 11, 2017 (DE) 10 2017 118 384.1

(51) Int. Cl. A47L 9/00

(52) U.S. Cl. CPC A47L 9/009; B60B 3/001; A47L 2201/00

(57) ABSTRACT

An automatically moving floor treatment appliance has at least one wheel, which can be rotated about an axis of rotation and which has a circumferential surface, wherein the circumferential surface has a plurality of profile blocks, which, based on the axis of rotation, face radially to the outside and which are embodied in succession in the circumferential direction. To facilitate a negotiating of obstacles by means of the floor treatment appliance, the profile blocks form a profile of the circumferential surface, which is completely heterogeneous in the circumferential direction, so that the structure of the profile is not repeated in the circumferential direction.

### CROSS REFERENCE TO RELATED APPLICATIONS

Applicant claims priority under 35 U.S.C. §119 of German Application No. 10 2017 118 384.1 filed on Aug. 11, 2017, the disclosure of which is incorporated by reference.

### BACKGROUND OF THE INVENTION

### 1. Field of the Invention

The invention relates to an automatically moving floor treatment appliance comprising at least one wheel, which can be rotated about an axis of rotation and which has a circumferential surface, wherein the circumferential surface has a plurality of profile blocks, which, based on the axis of rotation, face radially to the outside and which are embodied in succession in the circumferential direction.

The invention furthermore relates to a wheel, in particular for an above-mentioned floor treatment appliance, wherein the wheel can be rotated about an axis of rotation and has a circumferential surface, which has a plurality of profile blocks, which, based on the axis of rotation, face radially to the outside and which are embodied in succession in the circumferential direction.

### 2. Description of the Related Art

Automatically moving floor treatment appliances are known in the prior art, for example as autonomous cleaning robots, which can perform a vacuuming and/or mopping task. For the most part, the known floor treatment appliances have at least two drive wheels, which roll on the surface to be treated with its circumferential surface.

As is known from motor vehicles, floor treatment appliances are also equipped with profiled wheels, which allow for an improved power transfer to the surface to be treated. This is preferred, for example, when the floor treatment appliance is to move over an obstacle, such as for example a carpet edge or a doorstep.

Publications DE 10 2008 009 617 A1 and U.S. Pat. No. 6,633,150 A1 disclose for example mobile robots comprising profiled wheels, wherein the wheels have profile blocks, which are arranged in succession at regular intervals in the circumferential direction.

Even though profiled wheels already have advantages as compared to non-profiled wheels, it is nonetheless possible that the floor treatment appliance has to approach an obstacle, which is to be negotiated, repeatedly, so as to finally be able to negotiate it.

### SUMMARY OF THE INVENTION

Based on the above-mentioned prior art, it is the object of the invention to create an automatically moving floor treatment appliance or a wheel, respectively, for such a floor treatment appliance, in the case of which a favorable design is found in particular in view of a negotiation of obstacles.

To solve the object, it is proposed that the profile blocks form a profile of the circumferential surface, which is completely heterogenous in the circumferential direction, so that the structure of the profile is not repeated in the circumferential direction.

According to the invention, the wheel of the floor treatment appliance has a circumferential surface, i.e. running surface, comprising an irregularly designed profile. It is achieved thereby that, when the circumferential surface hits an obstacle, for example a doorstep, many profile blocks of different embodiments lend themselves, even if the drive wheel may spin, so that, as a whole, there is a higher likelihood as compared to homogenous profiles to hit a profile block, which can support itself on the obstacle and provides for a sufficient power transfer to the obstacle. As a whole, the moving characteristics of the floor treatment appliance, in particular the traction on different surfaces, such as for example different carpets or hard floors, as well as the climbing characteristics are thus improved. In addition, the track marks of the floor treatment appliance when moving over wet or soiled surfaces as well as on carpeted floors are minimized by means of the heterogenous profile. By avoiding a spinning of the wheels or a stopping of the floor treatment appliance, respectively, obstacles can be negotiated more quickly, which saves treatment time when using the floor treatment appliance. An enlarged cleaning area, in turn, can thus be attained per full charge of an accumulator.

It is in particular proposed that the profile blocks have different shapes relative to one another. The profile blocks can thereby be derived from different cross sectional shapes, for example round, angular, square, triangular and the like. However, the profile blocks can furthermore also have free-form surfaces, which have straight edges and/or curved edges.

The profile blocks can furthermore be formed so as to be polygonal, based on a cross section located in the circumferential direction. The larger the number of the sides of the polygonal cross sectional surface, the more likely it is that one of the sides stands in such a way that the wheel can support itself on an obstacle, which is to be negotiated.

In the alternative or in addition, it can also be provided that the profile blocks have different heights relative to one another, based on a radial direction of the wheel. It is in particular advisable that a plurality or all of the profile blocks have a height difference of more than 0.5 mm to other profile blocks. The front faces of the profile blocks, which form the circumferential surface of the wheel, thus protrude from the entire profile to different extents, so that some of the profile blocks protrude beyond others. It is thus possible that a plurality of profile blocks can simultaneously abut on an edge of the obstacle, thus resulting in a larger adhesive force as a whole. Areas, in which an obstacle can at least partially engage, furthermore result, if applicable in addition to spaces between the profile blocks, so that the power transfer of the floor treatment appliance to the surface can be optimized. In practice, a height difference of at least 0.5 mm has proven to be advantageous, wherein height differences of 1.0 mm, 1.5 mm, 2 mm or more can also be advantageous.

It is proposed that the profile blocks have different distances relative to one another. The adjacent profile blocks thus have different distances, so that a first profile block can have a different distance to a second profile block than to a third profile block. The profile blocks can for example be spaced apart from one another by less than 1 mm. However, distances of several millimeters are also possible. Partial areas, which do not have any profile blocks, can thus also result on the circumferential surface of the wheel, so that the adjacent profile blocks can contact the obstacle from different spatial directions. For example one side surface of a profile block thus engages with the obstacle. Even if the profile block thus does not contact the obstacle with a front face, a slipping of the wheel from the obstacle is nonetheless prevented.

It is in particular proposed that the profile blocks have spatial orientations relative to one another, based on the circumferential surface. Depending on the orientation and design of an obstacle to be negotiated, there is thus a high likelihood that one or a plurality of profile blocks of the wheel provide a loadable contact surface to the obstacle, so that it is possible to negotiate the obstacle.

It is furthermore proposed that the profile blocks are made of a material of a different hardness relative to one another. The profile blocks can in particular consist of an elastic plastic, in particular a flexible, rubber-like plastic, such as EPDM (ethylene-propylene-diene (monomer) caoutchouc). As a result of the elasticity of the material, the circumferential surface of the wheel is deformed when bearing on the surface or abutting on an obstacle, respectively, whereby a frictional resistance between the wheel and the traveled surface or the obstacle, respectively, increases. The drive force of the floor treatment appliance can thus be optimally transferred to the surface or the obstacle to be negotiated, respectively. If applicable, the circumferential surface of the wheel can also adapt to a shape or surface structure of the surface or of the obstacle respectively, which, in turn, increases the adhesive force.

It can be provided that the profile blocks have profile flanks, which are inclined relative to a radial direction. The profile flanks, i.e. the side surfaces, of the three-dimensional profile blocks, are thus not oriented in the radial direction, i.e. not perpendicular to the circumferential surface of the wheel, but are at an incline thereto. In addition, it can on principle also be provided that the front faces of one or a plurality of profile blocks is inclined relative to a tangent of the respective circumferential partial area. As a result of this measure, the options that a partial area of one or a plurality of profile blocks can engage with an obstacle to be navigated, are also increased with this measure.

In addition to the above-described floor treatment appliance, the invention furthermore proposes a wheel, in particular a wheel for a floor treatment appliance of the above-described type, wherein the wheel can be rotated about an axis of rotation and has a circumferential surface, which has a plurality of profile blocks, which, based on the axis of rotation, face radially to the outside and which are embodied in succession in the circumferential direction, wherein the profile blocks form a profile of the circumferential surface, which is completely heterogeneous in the circumferential direction, so that the structure of the profile is not repeated in the circumferential direction. The wheel according to the invention can be embodied as described above with reference to the floor treatment appliance. The features and advantages thereby also apply accordingly for the wheel according to the invention.

It can in particular be provided that the wheel has profile blocks comprising shapes, which differ from one another, heights, which differ from one another, distances, which differ from one another, spatial orientations, which differ from one another, hardnesses, which differ from one another, and further features, such as inclined profile flanks or a profile, which is repeated in adjacent segments.

### BRIEF DESCRIPTION OF THE DRAWINGS

The invention will be described in more detail below by means of exemplary embodiments.

FIG. 1 shows a perspective view of a floor treatment appliance according to the invention,

FIG. 2 shows a wheel according to the invention for a floor treatment appliance in a side view,

FIG. 3 shows a top view onto a partial area of a circumferential surface of the wheel.

### DETAILED DESCRIPTION OF THE PREFERRED EMBODIMENTS

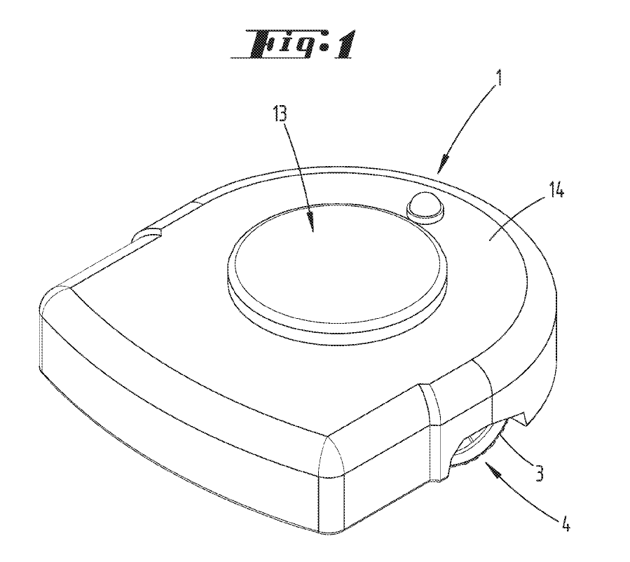

FIG. 1 initially shows a floor treatment appliance 1, which is embodied here for example as autonomous vacuum cleaning robot. Here, the floor treatment appliance 1 has a housing 14 and for example two wheels 4, which are motor driven. The floor treatment appliance 1 furthermore has a distance measuring device 13, which is accommodated in the housing 14 and which preferably comprises an optical sensor system. The distance measuring device 13 can for example have a triangulation measuring device, which measures distances to obstacles in the surrounding area of the floor treatment appliance 1. From the recorded data, a navigation and self-location device of the floor treatment appliance 1 can prepare a map of the surrounding area, by means of which the floor treatment appliance 1 can orientate itself in response to an automatic movement.

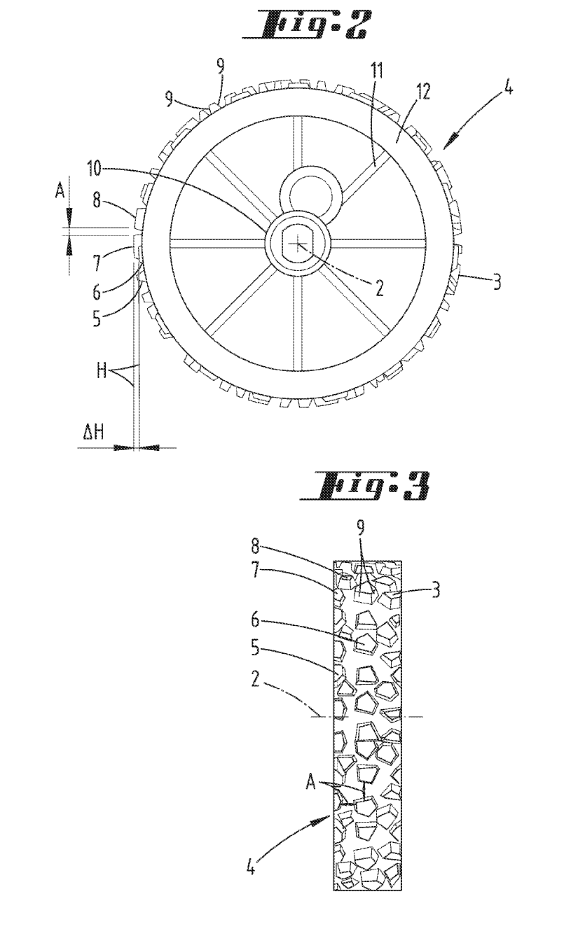

In detail, the wheels 4 have a hub 10, a plurality of spokes 11, and a tire 12 comprising a circumferential surface 3 (see also FIGS. 2 to 4). The circumferential surface 3 of the wheel 4 forms a contact surface, which rolls on a surface in response to a movement of the floor treatment appliance 1. The wheel 4 rotates about an axis of rotation 2 (suggested in FIG. 2), which is accommodated by the hub 10. The tire 12 has a profile comprising a plurality of profile blocks 5, 6, 7, 8. The profile blocks 5, 6, 7, 8 consist of an elastic material. It can for example be rubber, a rubber mixture, or a thermoplastic elastomer. In particular EPDM is proposed here as flexible, rubber-like plastic. The circumferential surface 3 is formed by the profile blocks 5, 6, 7, 8, wherein the profile blocks 5, 6, 7, 8 form a heterogenous profile, based on a circumferential direction as well as on an axial direction of the wheel 4 perpendicular thereto. In response to a typical moving stress of the floor treatment appliance 1 on a flat surface and without the special case of a cooperation of the wheel 4 with an obstacle, a contact surface of the wheel 4 with the traveled surface is only at hand by the front faces of the profile blocks 5, 6, 7, 8. The profile blocks 5, 6, 7, 8, together with further surfaces of the tire 12, which point in the radial direction, form the circumferential surface 3. Every area of the circumferential surface 3 can come into contact with a surface or an obstacle, respectively, at least theoretically. Areas aside from the front faces of the profile blocks 5, 6, 7, 8 can thereby also at least temporarily become part of the contact surface of the wheel 4.

Different possible features of the profile of the wheel 4 will be illustrated below by means of FIGS. 2 to 4. Here, the profile blocks 5, 6, 7, 8 have a plurality of possible features, which could, however, also be used alone, as an alternative, so that a plurality of other embodiments with subcombinations or also features on their own can result. The shown exemplary embodiment is to not be understood to be limiting in this respect.

FIG. 2 shows a side view of an exemplary wheel 4, the circumferential surface 3 of which has a plurality of profile blocks 5, 6, 7, 8, which, based on the axis of rotation 2, face radially to the outside and which are embodied in succession in the circumferential direction. Here, only four profile blocks 5, 6, 7, 8 of the plurality of illustrated profile blocks are provided with reference numerals. The profile of the wheel 4 can be completely heterogeneous in the circumferential direction or can have segments, which have an identical arrangement of profile blocks 5, 6, 7, 8, so that the structure of the profile is repeated at defined intervals in the circumferential direction. The profile blocks 5, 6, 7, 8, which are quantified in an exemplary manner in the figure, have shapes, heights H and distances A, which differ from one another. As can be seen from FIG. 3, the profile blocks 5 to 8 also have spatial orientations, which differ from one another. The profile flanks 9 of at least some of the profile blocks 5, 6, 7, 8 are furthermore not oriented perpendicular to the circumferential surface 3, but are inclined relative to a radial direction. It goes without saying, however, that it is also possible that the profile blocks 5, 6, 7, 8 have steeply sloping profile flanks 9. On principle, overhangs of the profile flanks 9 are possible as well.

Based on their front face, i.e. running surface, which points radially to the outside, the profile blocks 5, 6, 7, 8 as well as the cross sections located therebelow are of a polygonal design, here with four or more side surfaces. The profile blocks 5, 6, 7, 8 also have different heights H. The profile block 6 for example has a smaller height H than the profile block 7. Here, there is for example a height difference ΔH of 1 mm. The distances A of the profile blocks 5, 6, 7, 8 are furthermore also dimensioned differently. As can be seen in FIGS. 3 and 4, the distances A vary from almost 0 to up to several millimeters. The distances A are partially as large as one side of a front face of a profile block 5, 6, 7, 8.

The wheel 4 is not necessarily illustrated true to scale here. A typical wheel 4 for a floor treatment appliance 1 can for example have a diameter of 75 mm and an axial width of 13 mm. In addition, the wheel 4 also does not need to be embodied with a hub 10, spokes 11, and a tire 12. In the alternative, the wheel 4 can in fact be a full material wheel.

The illustrated features of the wheel 4, in particular the special features of the profile blocks 5, 6, 7, 8, ensure that the wheel 4 offers a plurality of completely differently oriented profile edges, when hitting an obstacle, so that, compared to regular profiles, there is an increased likelihood of finding a profile block 5, 6, 7, 8, the profile edge of which engages sufficiently firmly with the obstacle, so that the obstacle can be navigated. When moving over obstacles, such as doorsteps and/or ledges, the wheel 4 always finds a partial area of the circumferential surface 3, which can support itself on the obstacle and pull itself up thereon, as a result of the asymmetrically embodied profile structure of irregularly designed profile blocks 5, 6, 7, 8, which consist of a plurality of nub-shaped polygons here and which are distributed in random size and orientation. The profile blocks 5, 6, 7, 8 can furthermore have materials of a different hardness, so that some of the profile blocks 5, 6, 7, 8 are softer or harder than others.

### LIST OF REFERENCE NUMERALS

1 floor treatment appliance
2 axis of rotation
3 circumferential surface
4 wheel
5 profile block
6 profile block
7 profile block
8 profile block
9 profile flank
10 hub
11 spoke
12 tire
13 distance measuring device
14 housing
A distance
H height
ΔH height difference

What is claimed is:

1. An automatically moving floor treatment appliance comprising:
at least one wheel, which is configured to be rotated about an axis of rotation and which has a circumferential surface,
wherein the circumferential surface has a plurality of profile blocks, which, based on the axis of rotation, face radially to an outside and which are embodied in succession in a circumferential direction,
wherein the profile blocks form a profile of the circumferential surface, which is completely heterogeneous in the circumferential direction, so that a structure of the profile is not repeated in the circumferential direction.

2. The floor treatment appliance according to claim 1, wherein the profile blocks have shapes that differ from one another.

3. The floor treatment appliance according to claim 1, wherein the profile blocks are formed so as to be polygonal, based on a cross section located in the circumferential direction.

4. The floor treatment appliance according to claim 1, wherein the profile blocks have different heights relative to one another, as measured in a radial direction of the wheel.

5. The floor treatment appliance according to claim 1, wherein the profile blocks have different distances relative to one another.

6. The floor treatment appliance according to claim 1, wherein the profile blocks have different spatial orientations relative to one another, based on the circumferential surface.

7. The floor treatment appliance according to claim 1, wherein the profile blocks are made of material of a different hardness relative to one another.

8. The floor treatment appliance according to claim 1, wherein the profile blocks have profile flanks, which are inclined relative to a radial direction.

9. A wheel for a floor treatment appliance, wherein the wheel can be rotated about an axis of rotation and has a circumferential surface, which has a plurality of profile blocks, which, based on the axis of rotation, face radially to the outside and which are embodied in succession in the circumferential direction,
wherein the profile blocks form a profile of the circumferential surface, said profile being completely heterogeneous in the circumferential direction, so that a structure of the profile is not repeated in the circumferential direction.
